(19) United States
(12) Patent Application Publication
(10) Pub. No.: US 2025/0336909 A1
(43) Pub. Date: Oct. 30, 2025

(54) METHOD FOR GENERATING ORDERED ION CHANNELS, ITS ELECTROCHEMICAL DEVICE COMPONENT AND ELECTROCHEMICAL DEVICE

(71) Applicant: National Taiwan University of Science and Technology, Taipei (TW)

(72) Inventors: Bing-Joe Hwang, Taipei (TW); Yosef·Nikodimos Asgedom, Taipei (TW); Sheng-Chiang Yang, Taipei (TW); Wei-Nien Su, Taipei (TW); Zabish Bilew Muche, Taipei (TW)

(21) Appl. No.: 19/185,948

(22) Filed: Apr. 22, 2025

(30) Foreign Application Priority Data
Apr. 29, 2024 (TW) 113115882

(51) Int. Cl. H01M 4/04; H01M 4/02; H01M 4/583; H01M 4/66; H01M 4/75; H01M 10/0565; H01M 10/0566

(52) U.S. Cl. CPC H01M 4/0404; H01M 4/583; H01M 4/661; H01M 4/667; H01M 4/668; H01M 4/75; H01M 10/0565; H01M 10/0566; H01M 2004/027; H01M 2004/028

(57) ABSTRACT

The present invention utilizes thin film deposition technology to directly deposit a compound of electrode affinity, hydrogen, and carbon atoms and its derivatives or composites onto the surface of an electrode foil, positive electrode plate or negative electrode plate to form an electrospun membrane which can directly serve as a separator membrane in an electrochemical device. Due to the strong affinity of the deposited thin film membrane to the surface of the electrode foil, positive electrode plate or negative electrode plate via thin film deposition process's attraction, a binding interface thereof exhibits an ordered ion channel layer which can serve as a beneficial artificial electrolyte interface layer on the current collector or electrodes.

### FIELD OF INVENTION

The present invention is related to a method for generating ordered ion channels, in particular a method for generating ordered ion channels on a current collector or electrodes in an electrochemical device, and its electrochemical device component and electrochemical device.

### BACKGROUND OF THE INVENTION

The conventional electrochemical devices (or batteries) use a foreign separator to selectively accept ions shuttling in between electrodes of anode and cathode during its life cycle. However, an uncontrollable solid electrolyte interface (SEI) often grow randomly and irregularity on the electrodes causing high interface impedance to the electrochemical device.

Currently, there are no any separators directly fabricated on a current collector or electrode, and have no artificially ordered ion channels at the electrode interface to avoid the formation of the irregular solid electrolyte interface. Hence, it is eager to have a solution that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to improve upon the conventional electrochemical device using the separator which is not fabricated directly on the current collector or electrode, the present invention provides a method for generating ordered ion channels, comprising the steps of:
providing an reaction solution, wherein the reaction solution contains a compound of electrode affinity, hydrogen, and carbon atoms;
using an thin film deposition device to deposit the reaction solution onto a current collector, a positive electrode plate surface, or a negative electrode plate surface to form an deposited thin film layer; wherein the current collector contains a fluorophilic or fluorinatable metal;
an ordered ion channel layer is formed between the deposited thin film layer and the current collector, or between the deposited thin film layer and the positive electrode plate, or between the deposited thin film layer and the negative electrode plate; and
the ordered ion channel layer contains a compound of electrode affinity, hydrogen, and carbon atoms, and at least 50% of the electrode affinity atoms are attached to the surface of the current collector, the positive electrode plate, or the negative electrode plate, and at least 50% of the hydrogen atoms are oriented away from the surface of the current collector, the positive electrode plate, or the negative electrode plate.

Further, the present invention also provides an electrochemical device component having an ordered ion channel, comprising the ordered ion channel deposited thin film layer on the current collector, the positive electrode plate, or the negative electrode plate as obtained by the aforementioned method. Preferably, the ordered ion channel deposited thin film layer on the current collector, the positive electrode plate, or the negative electrode plate is further immersed in a gel electrolyte or a liquid electrolyte.

The present invention also provides an electrochemical device comprising the aforementioned electrochemical device component, wherein the electrochemical device comprises a metal ion battery, a metal battery, a metal ion-metal hybrid battery, or an anode-free battery.

From the above description, it can be known that the present invention has the following beneficial effects and advantages:
1. The present invention utilizes thin film deposition technology to directly electrospun polyvinylidene fluoride and its derivatives or composites onto the surface of a current collector or positive/negative electrode plates to form a deposited thin film membrane which can directly serve as the separator membrane in the electrochemical device. Due to the strong affinity of the deposited thin film membrane to the surfaces of the current collector or positive/negative electrode plates via electrostatic attraction, a binding interface thereof exhibits the ordered ion channel layer which can serve as a beneficial artificial electrolyte interface layer on the current collector or electrodes.
2. The deposited thin film membrane of the present invention can simultaneously serve as the separator membrane in the electrochemical device. Together with the current collector immersed in the electrolyte, a gel polymer electrolyte can be formed and directly assembled as an electrochemical battery, such as an anode-free battery. Compared with the existing electrospun separator membranes, which require additional processes such as membrane removal, immersion, and assembly with the current collector or positive/negative electrode plates, the present invention is relatively simple and fast. At the same time, the advantageous artificial electrolyte interface layer acts as the ion channel layer which can effectively allow the passage of electrochemical reaction metal ions, thereby improving the electrochemical performance.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a process flow diagram of a method for generating ordered ion channels according to the present invention;

FIG. 2 is a schematic diagram of a preferred embodiment of an electrochemical device component having ordered artificial ion channels according to the present invention;

FIG. 3 is an X-ray photoelectron spectroscopy diagram of a preferred embodiment of an electrochemical device component having ordered artificial ion channels according to the present invention;

FIGS. 4 and 5 show proton energy spectra comparing a comparative example and a preferred embodiment of an electrochemical device component having ordered artificial ion channels according to the present invention;

FIG. 6 is a focused ion beam-scanning electron microscope cross-sectional image of a preferred embodiment of an electrochemical device component having ordered artificial ion channels according to the present invention after lithium deposition in the first cycle in a half-cell;

FIGS. 7A-7E show various electrochemical performance diagrams of a half-cell for a preferred embodiment of an electrochemical device component having ordered artificial ion channels according to the present invention; and

FIGS. 8A-8C show voltage, areal specific capacitance, discharge capacitance, and coulombic efficiency performance during multiple charge/discharge cycles for a comparative example and an embodiment of the present invention with electrospinning on the negative electrode plate.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. A Iso, as used in the description herein and throughout the claims that follow, the terms “comprise or comprising”, “include or including”, “have or having”, “contain or containing” and the like are to be understood to be open-ended, i.e., to mean including but not limited to.

### <Method for Generating Ordered Ion Channels>

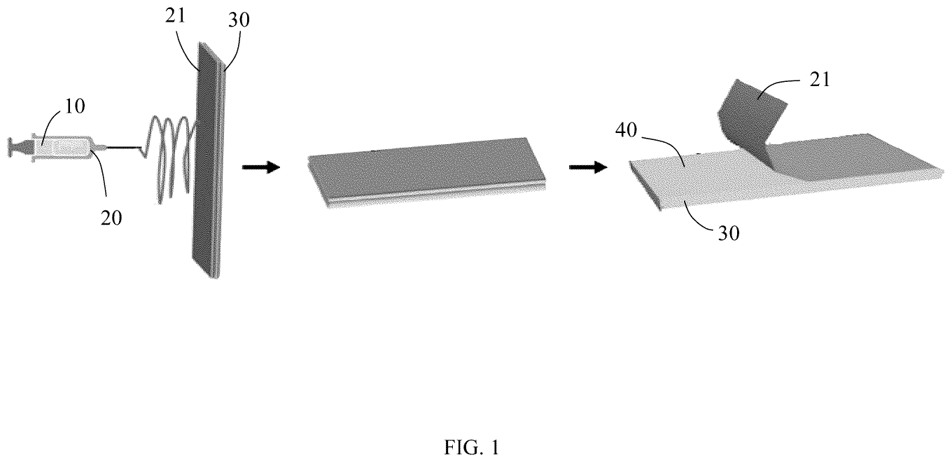

Please refer to FIG. 1, which is a process flow diagram of a method for generating ordered ion channels according to the present invention. The steps include:

Step S1: Providing an reaction solution 10, wherein the reaction solution 10 contains a compound of electrode affinity, hydrogen, and carbon atoms; the said electrode affinity atom contains but not limited to one of Fluorine (F), Antimony (Sb), Magnesium (Mg), Calcium (Ca), Strontium (Sr), Barium (Ba), Scandium (Sc), Yttrium (Y), Aluminium (Al), Gallium (Ga), Indium (In), Titanium (Ti), Silicon (Si), Germanium (Ge), Tin (Sn), Lead (Pb), Arsenic (As), Bismuth (Bi), Selenium (Se), Tellurium (Te), Rhodium (Rh), Iridium (Ir), Palladium (Pd), Platinum (Pt), Silver (Ag), Gold (Au), Zinc (Zn), Cadmium (Cd), Niobium (N b), Oxygen (O), Nitrogen (N), Molybdenum (Mo) and Mercury (Hg) or combination thereof.

Step S2: Using an thin film deposition device 20 to deposit the reaction solution 10 onto a surface of a current collector 30, a positive electrode plate surface (not shown in the figures), or a negative electrode plate surface (not shown) to form an deposited thin film layer 21;

Step S3: A n ordered ion channel layer 40 is formed between the deposited thin film layer 21 and the current collector 30, the positive electrode plate, or the negative electrode plate.

The thin film deposition described in step 2 includes electrospinning method, template method, spray coating method or spin coating method.

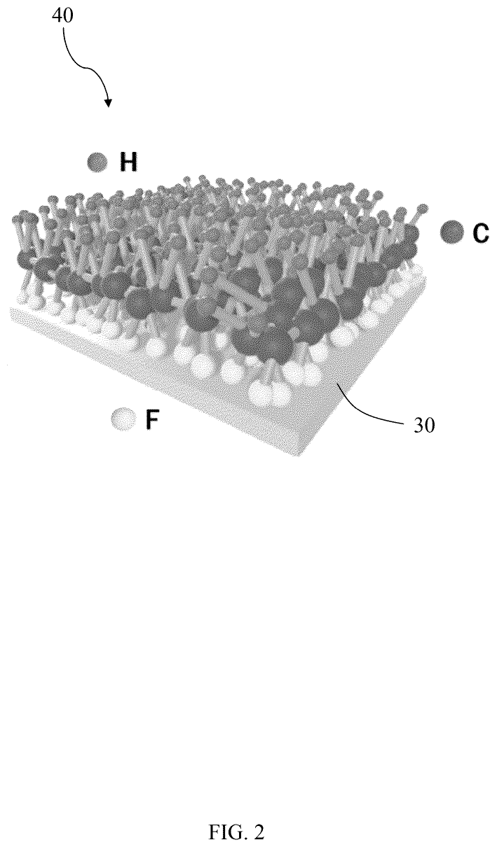

Refer to FIG. 2. The ordered ion channel layer 40 contains a compound of electrode affinity, hydrogen and carbon atoms. At least 50%, better 70%, preferably 80%, or best 90% of the electrode affinity atoms are attached to the surface of the current collector 30, the positive electrode plate, or the negative electrode plate; and at least 50%, better 70%, preferably 80%, or best 90% of the hydrogen atoms are oriented away from the surface of the current collector 30, the positive electrode plate, or the negative electrode plate, thereby forming a highly ordered ion channel layer 40. In some preferred embodiments, the deposited thin film layer 21 can directly serve as a separator membrane in an electrochemical device without separate the deposited thin film layer 21 away from a substrate in the conventional technique.

<Electrochemical Device Component with Ordered Artificial Ion Channels>

A s shown in FIG. 2, corresponding to the aforementioned method for generating ordered ion channels, the present invention also provides an electrochemical device component manufactured by this method, comprising: the deposited thin film layer 21, the ordered ion channel layer 40, and the current collector 30, the positive electrode plate, or the negative electrode plate sequentially stacked and bonded together.

W herein, the deposited thin film layer 21 can be used as the separator membrane for the electrochemical device component; the current collector 30 is used as an electrode (positive or negative), for example, it can be used in an anode-free device; the positive electrode plate preferably contains a positive electrode material and is directly used as the positive electrode in a conventional electrochemical device; the negative electrode plate preferably contains a negative electrode material and is used as the negative electrode in the conventional electrochemical device; and the ordered ion channel layer 40 facilitates the passage of metal ions participating in the electrochemical reaction during charge/discharge of the electrochemical device to reach the current collector 30, the positive electrode plate, or the negative electrode plate, avoiding the generation of harmful dendritic structures and improving the electrochemical performance of the electrochemical device. The metal ions participating in the electrochemical reaction preferably include lithium ions, sodium ions, magnesium ions, potassium ions, aluminum ions, or zinc ions. The electrochemical component is a metal ion battery, a metal battery, a metal ion-metal hybrid battery, or an anode-free battery.

### PREFERRED EMBODIMENTS OF THE PRESENT INVENTION

The reaction solution 10 is a electrospinning solution including polyvinylidene fluoride (PV DF) and its derivatives or composites. Preferred embodiments include a polyvinylidene fluoride solution or a polyvinylidene fluoride-hexafluoropropylene copolymer (PVDF-HFP) solution. Further, the polyvinylidene fluoride (PVDF) may also include polyimide (PI), fluorinated polyimide (FPI), polyethylene oxide (PEO), poly(methyl methacrylate) (PMMA), polyacrylonitrile (PAN), polyvinyl chloride (PVC), or their derivatives.

The reaction solution 10 may preferably further include a filler, wherein the ratio of PV DF-H FP to the filler is between 0.1-90 wt %, more preferably between 0.1-80 wt %, and most preferably between 0.1-70 wt %. The filler preferably includes Li_{1+x+2y}AlₓMg_{y}Ge_{2-x-y}(PO₄)₃, where x and y are positive numbers between 0-100. Preferred embodiments of the filler include Li_{1.6}Al_{0.4}Mg_{0.1}Ge_{1.5}(PO₄)₃ (x=0.4, y=0.1, LAMGP); or Kevlar, which can increase the strength and hardness of the PVDF-HFP thin film, and this filler helps to repel anions, allowing metal ions to pass through the ordered ion channels more easily. The filler can also include a garnet-type filler (Garnet), such as lithium lanthanum zirconate (LLZO); a perovskite-type filler (Perovskites), such as lithium lanthanum titanate (LLTO); a sodium super-ionic conductor-type (NASICON) filler, such as LAGP or LATP; a metal-organic framework (MOFs) filler; or a filler with a three-dimensional porous ceramic framework.

The thin film deposition device 20 is any commercially available thin film deposition device to pratice electrospinning method, template method, spray coating method or spin coating method. The reaction solution 10 in this preferred embodiment as electrospinning solution is injected into the syringe of the thin film deposition device 20, and thin film depotion is carried out onto the current collector 30, the positive electrode plate, or the negative electrode plate using process parameters of a 14.3 kV high direct current (DC) voltage and a distance of 15 cm.

The prepared deposited thin film layer 21, ordered ion channel layer 40, and current collector 30, positive electrode plate, or negative electrode plate are dried in a vacuum oven at 80° C. for 4 hours. After drying, the deposited thin film layer 21, ordered ion channel layer 40, and current collector 30, positive electrode plate, or negative electrode plate are immersed in 3 m LiFSI (LiFSI dissolved in EC/DMC 1:1 v %) for 3 hours, and then wiped with filter paper in an argon-filled glovebox to obtain the desired electrode structure of the deposited thin film layer 21, ordered ion channel layer 40, and current collector 30, positive electrode plate, or negative electrode plate according to the preferred embodiment of the present invention.

Preferably, the deposited thin film layer 21, ordered ion channel layer 40, and current collector 30, positive electrode plate, or negative electrode plate of the preferred embodiment of the present invention may also be immersed in a gel or liquid electrolyte to increase the metal ion conductivity for subsequent assembly into an electrochemical battery.

The current collector 30 is preferably fluorophilic or a fluorinatable metal, including copper foil, aluminum foil, nickel foil, titanium foil, gold foil, platinum foil, or stainless steel foil. After drying, the thickness of the deposited thin film layer 21 and the ordered ion channel layer 40 is approximately 60-70 μm.

The positive electrode plate contains a positive electrode material, such as lithium cobalt oxide, lithium ternary material, lithium manganese oxide, lithium iron phosphate or lithium manganese iron phosphate, layered transition metal oxides, Prussian blue, polyanionic compounds, or tunnel-structured oxide. The negative electrode plate contains a negative electrode material, such as silicon materials, carbon materials, nitrides, tin materials, or any combination thereof; wherein the carbon materials include hard carbon, soft carbon, or graphite materials, and the graphite material preferably can be mesocarbon microbeads (MCMB).

### COMPARATIVE EXAMPLES

To demonstrate that the ordered ion channel layer 40 is actually generated by the aforementioned method of the present invention, a comparative example provided by the present invention involves thin film deposition (like electrospinning) the same reaction solution 10 onto a substrate, followed by removing the deposited thin film layer 21 from the substrate, and then attaching it to the surface of the current collector, the positive electrode plate, or the negative electrode plate to obtain an electrochemical component structure with the deposited thin film layer 21 and the current collector, positive electrode plate, or negative electrode plate.

Similarly, for the comparative example, the prepared deposited thin film layer 21 and the current collector, positive electrode plate, or negative electrode plate are dried in a vacuum oven at 80° C. for 4 hours, then the dried deposited thin film layer 21 and current collector, positive electrode plate, or negative electrode plate are immersed in 3 m LiFSI (LiFSI dissolved in EC/DMC 1:1 v %) for 3 hours, and subsequently wiped with filter paper in the argon-filled glove box to obtain the required comparative example samples.

### <Verification Tests>

TABLE 1
List of preferred embodiments of the present invention and comparative
examples. The thin film deposition described in Table 1 includes
electrospinning method, template method, spray coating method or
spin coating method. All embodiment listed in Table 1 are validated
and proven effective with the claimed function or abilities.

| | Notation in | Thin film | Battery |
|---|---|---|---|
| Sample | Figures | depostion On | Type |
| Embodiment 1 | Cu@GPE\|NMC | PVDF-HFP containing | Lithium |
| | | LAMGP thin | metal battery |
| | | film deposit | |
| | | on copper foil. | |
| Embodiment 2 | PVDF- | PVDF-HFP containing | Lithium-ion |
| | HFP@MCMB | Kevlar thin | battery |
| | | film deposit on | |
| | | negative electrode | |
| | | plate. | |
| Comparative | Cu\|Celgard\|NMC | commercial Celgard | Lithium |
| Example 1 | | separator used | metal battery |
| | | (not thin | |
| | | film deposit) | |
| Comparative | Cu\|cGPE\|NMC | PVDF-HFP containing | Lithium |
| Example 2 | | LAMGP thin | metal battery |
| | | film deposit | |
| | | on substrate, | |
| | | then peeled | |
| | | off and attached | |
| | | to copper foil. | |
| Comparative | PVDF-HFP | PVDF-HFP containing | Lithium-ion |
| Example 3 | | Kevlar thin film | battery |
| | | deposit on | |
| | | substrate, then | |
| | | peeled off | |
| | | and directly | |
| | | assembled into | |
| | | lithium-ion | |
| | | battery as | |
| | | separator. | |

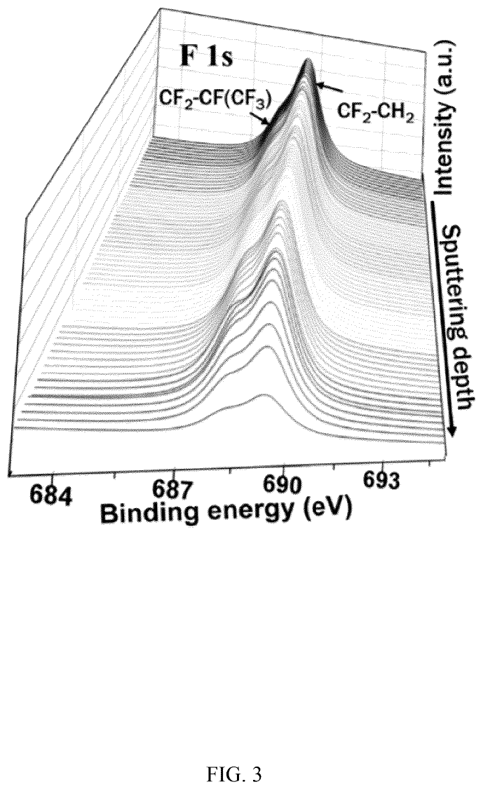

Refer to FIG. 3, which shows the X-ray photoelectron spectroscopy (XPS) diagram of a preferred embodiment of the electrochemical device component having ordered artificial ion channels (in this embodiment, electrospun on the current collector) obtained by the aforementioned method. FIG. 3A shows a high electrode affinity (fluorine) atom signal on the surface of the current collector 30, and a hydrogen atom signal in the direction away from the surface of the current collector 30, indicating that the present invention actually attaches at least 95% of the electrode affinity (fluorine) atoms to the surface of the current collector 30, and at least 95% of the hydrogen atoms are oriented away from the surface of the current collector 30.

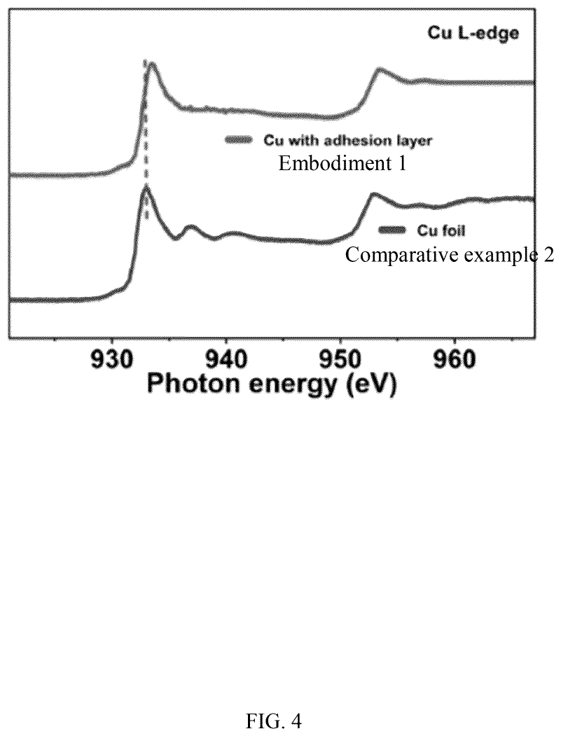

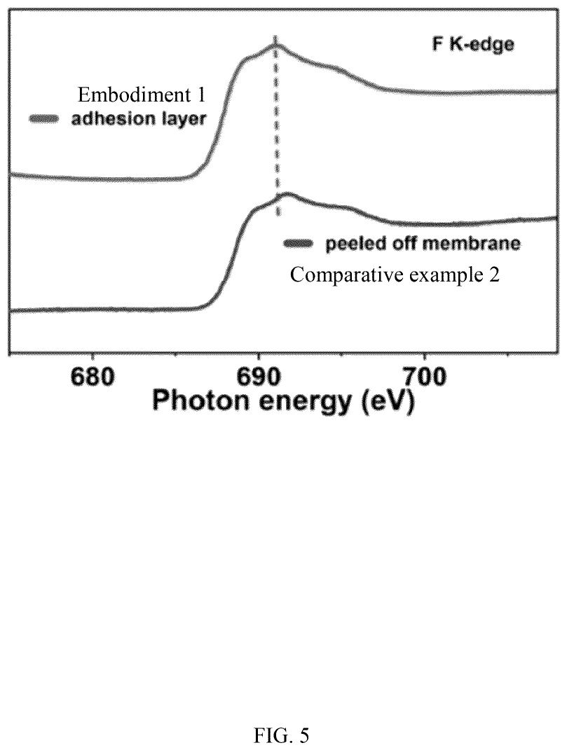

FIGS. 4 and 5 show the proton energy spectra of the aforementioned comparative examples and embodiments of the present invention. From the diagrams, it can be seen that there is a high electrode affinity (fluorine) atom signal on the surface of the current collector 30, indicating that the present invention actually attaches at least 95% of the electrode affinity (fluorine) atoms to the surface of the current collector 30, which forms the ordered ion channel layer 40.

Next, the preferred Embodiment 1 of the present invention was prepared into an anode-free lithium metal half-cell (AFLMB) and subjected to charge/discharge cycling. Wherein, Embodiment 1 of the present invention involved electrospinning PVDF-HFP containing the LAMGP filler onto copper foil, and the copper foil containing the deposited thin film layer was assembled into an A FL M B. Comparative Example 1 was Cu|Celgard|Li, and Comparative Example 2 was Cu|cGPE|Li, where PV DF-H FP was electrospun onto a substrate, then peeled off and attached to copper foil.

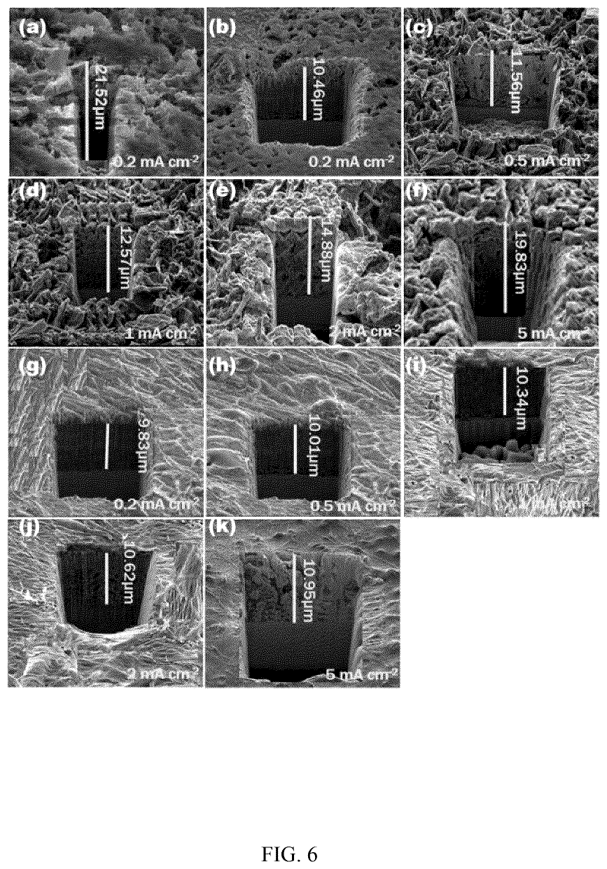

As shown in FIG. 6, it is a focused ion beam-scanning electron microscope (FIB-SEM) cross-sectional image of a preferred embodiment of an electrochemical device component having ordered artificial ion channels according to the present invention after lithium deposition in the first cycle of a half-cell. In FIG. 6, (a) is for Comparative Example 1, (b, f) are for Comparative Example 2 at different current densities, and (g, k) are for Embodiment 1 of the present invention at different current densities. (i) shows the densities (%) of lithium deposition relative to the theoretical thickness for the batteries of Comparative Example 2 and Embodiment 1 of the present invention as a function of current density. From FIG. 6, it can be seen that the ordered ion channels in the A FL M B of the present invention actually facilitate the passage of lithium ions and reduce the formation of lithium dendrites.

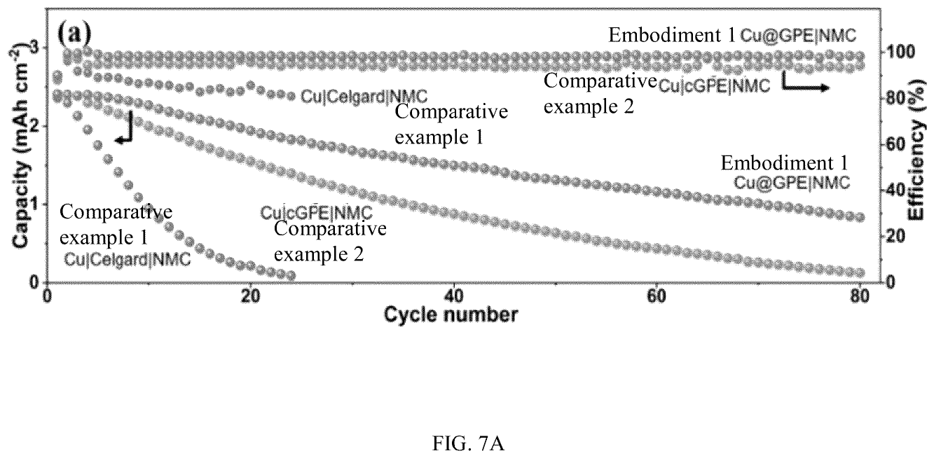

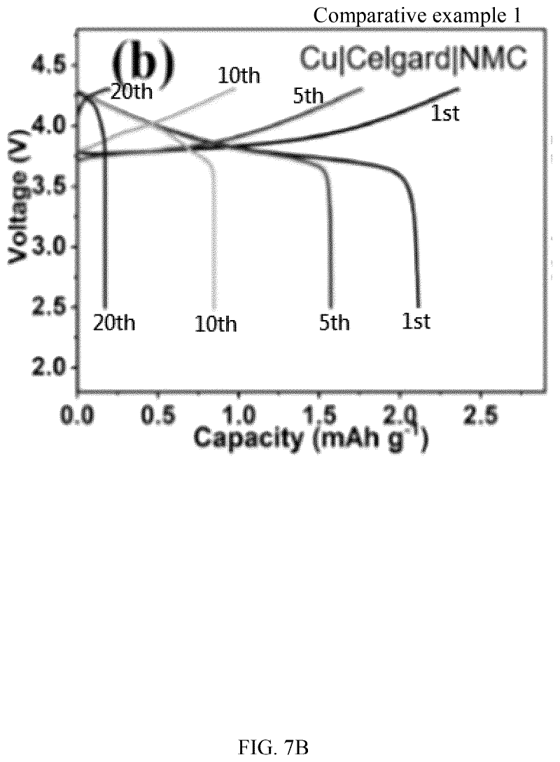

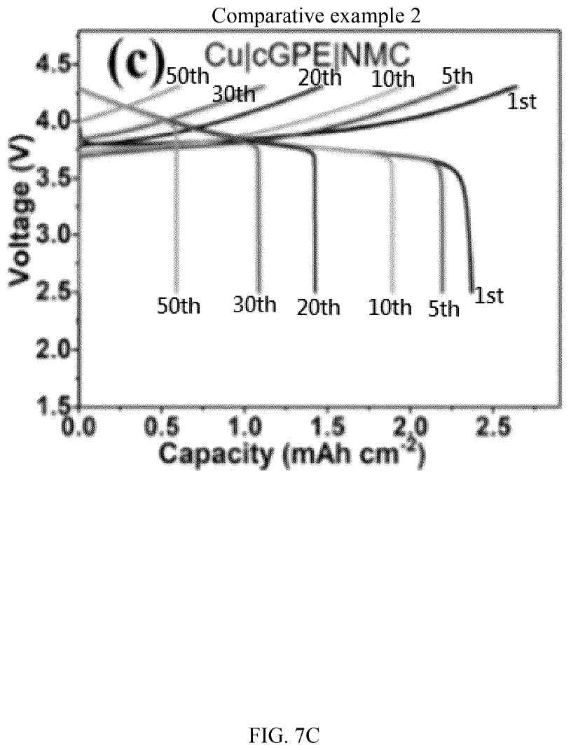

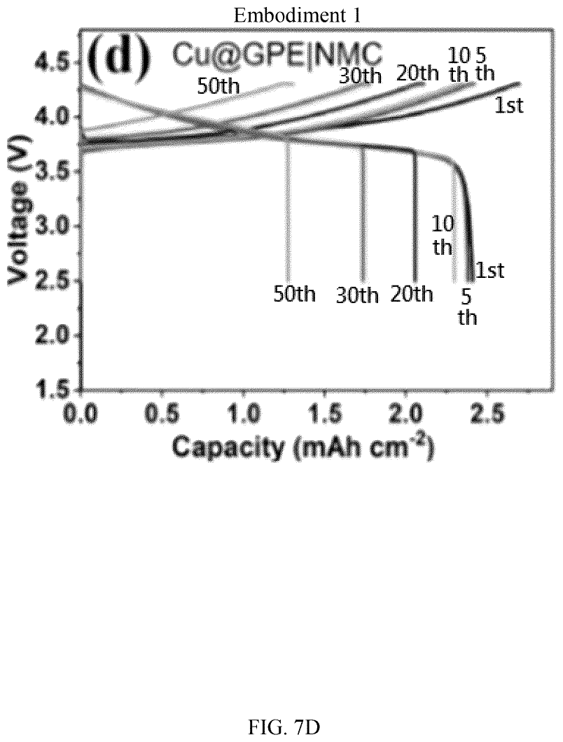

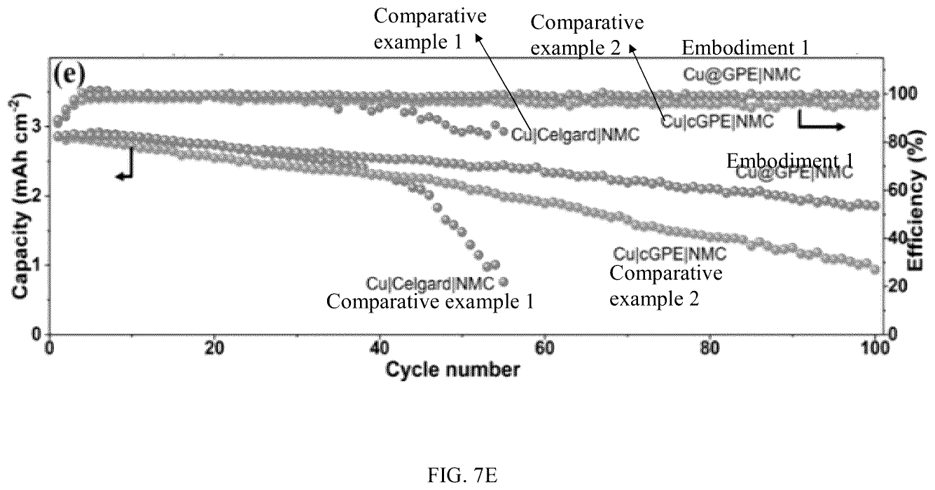

Refer to FIGS. 7A-7E, where FIG. 7A shows the charge/discharge cycling curves of the electrochemical properties at a current density of 0.5 mA cm⁻² for Embodiment 1 of the present invention, Comparative Examples 1 and 2. FIG. 7B is the voltage-capacitance diagram for Comparative Example 1, FIG. 7C is the voltage-capacitance diagram for Comparative Example 2, and FIG. 7D is the voltage-capacitance diagram for Embodiment 1 of the present invention. FIG. 7E shows the electrochemical performance of Embodiment 1 of the present invention using pre-lithiated copper foil cycled at a current density of 0.5 mA cm⁻². Comparative Example 1 degraded rapidly after 40 cycles, with a CE of only 95.6% after 55 cycles and a capacity retention of only 26.6%. After 100 cycles, the capacity retention of the battery of Embodiment 1 of the present invention was 65.0%, and the CE was 99.1%, while the capacity retention of the pre-lithiated battery of Embodiment 1 of the present invention was 32.8%, and the CE was 96.7%, as shown in FIG. 7E.

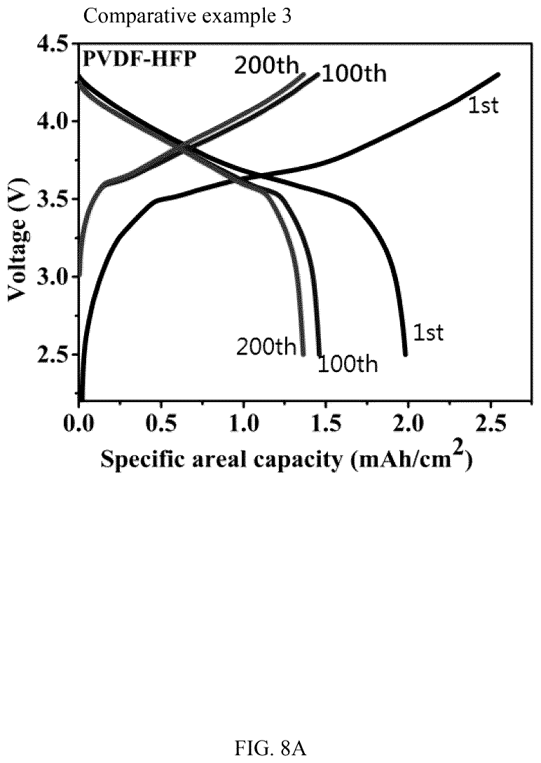

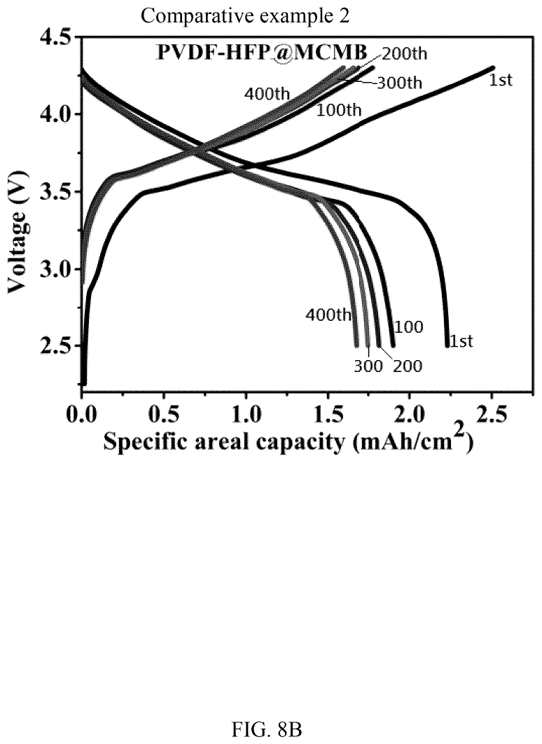

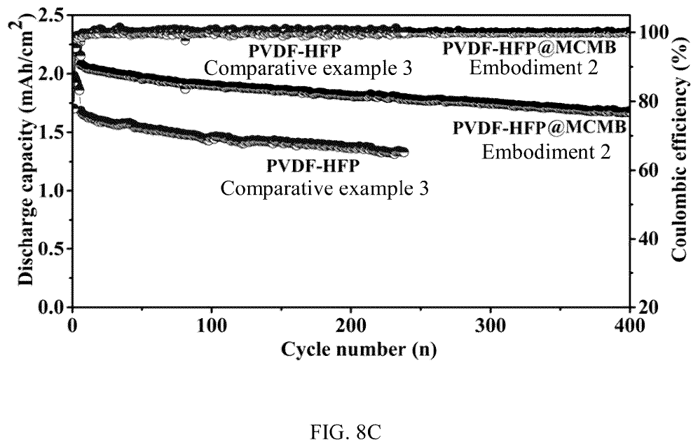

Refer to FIGS. 8A-8B, which show the voltage and areal specific capacitance diagrams for Comparative Example 3 (PV DF-H FP/Kevlar directly as a separator) and Embodiment 2 of the present invention with PVDF-HFP containing Kevlar filler electrospun onto the negative electrode plate. From the diagrams, it can be seen that Embodiment 2 of the present invention maintains a high specific capacitance even after 400 charge/discharge cycles. FIG. 8C shows the discharge capacitance and coulombic efficiency performance at multiple cycle numbers for Comparative Example 3 and Embodiment 2 of the present invention with electrospinning on the negative electrode plate. From FIG. 8C, it can be seen that the electrochemical performance of Comparative Example 3 deteriorates rapidly after around 200 cycles, while Embodiment 2 of the present invention exhibits excellent electrochemical performance even after 400 cycles.

The above specification, examples, and data provide a complete description of the present disclosure and use of exemplary embodiments. A though various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A method for generating ordered ion channels, comprising the steps of:
providing an reaction solution, wherein the reaction solution contains a compound of electrode affinity, hydrogen, and carbon atoms;
using an thin film deposition device to deposit the reaction solution onto a current collector, a positive electrode plate surface, or a negative electrode plate surface to form an deposited thin film layer, wherein the current collector contains a fluorophilic or fluorinatable metal;
an ordered ion channel layer is formed between the deposited thin film layer and the current collector, or between the deposited thin film layer and the positive electrode plate, or between the deposited thin film layer and the negative electrode plate; and
the ordered ion channel layer contains a compound of electrode affinity, hydrogen, and carbon atoms, with at least 50% of the electrode affinity atoms attached to the surface of the current collector or the negative electrode plate, and at least 50% of the hydrogen atoms oriented away from the surface of the current collector, the positive electrode plate, or the negative electrode plate.

2. The method according to claim 1, wherein the compound of electrode affinity atom contains one of Fluorine (F), Antimony (Sb), Magnesium (Mg), Calcium (Ca), Strontium (Sr), Barium (Ba), Scandium (Sc), Yttrium (Y), Aluminium (Al), Gallium (Ga), Indium (In), Titanium (Ti), Silicon (Si), Germanium (Ge), Tin (Sn), Lead (Pb), Arsenic (As), Bismuth (Bi), Selenium (Se), Tellurium (Te), Rhodium (Rh), Iridium (Ir), Palladium (Pd), Platinum (Pt), Silver (Ag), Gold (Au), Zinc (Zn), Cadmium (Cd), Niobium (Nb), Oxygen (O), Nitrogen (N), Molybdenum (Mo) and Mercury (Hg) or combination thereof.

3. The method according to claim 1, wherein the compound of electrode affinity, hydrogen, and carbon atoms comprises polyvinylidene fluoride and its derivatives or composites.

4. The method according to claim 3, wherein the polyvinylidene fluoride comprises a polyvinylidene fluoride-hexafluoropropylene copolymer.

5. The method according to claim 4, wherein the polyvinylidene fluoride and its derivatives or composites further comprise polyimide, fluorinated polyimide, polyethylene oxide, poly(methyl methacrylate), polyacrylonitrile, polyvinyl chloride, or derivatives thereof.

6. The method according to claim 1, wherein the reaction solution further comprises a filler, and the ratio of the compound to the filler is between 0.1-95 wt %.

7. The method according to claim 6, wherein the filler comprises Li_{1+x+2y}AlₓMg_{y}Ge_{2-x-y}(PO₄)₃, where x and y are positive numbers between 0-100; or Kevlar, a garnet-type filler, a perovskite-type filler, a sodium super-ionic conductor-type filler, a metal-organic framework filler, or a filler with a three-dimensional porous ceramic framework.

8. The method according to claim 7, wherein the garnet-type filler comprises lithium lanthanum zirconate, the perovskite-type filler comprises lithium lanthanum titanate, and the sodium super-ionic conductor-type filler comprises LAGP or LATP.

9. The method according to claim 8, wherein the deposited thin film layer, the ordered ion channel layer, and the current collector, the positive electrode plate, or the negative electrode plate are further immersed in a gel electrolyte or a liquid electrolyte.

10. The method according to claim 1, wherein the current collector comprises copper foil, aluminum foil, nickel foil, titanium foil, gold foil, stainless steel foil, or platinum foil.

11. The method according to claim 1, wherein the negative electrode plate comprises a negative electrode material including silicon materials, carbon materials, nitrides, tin materials, or any combination thereof.

12. The method according to claim 11, wherein the carbon materials comprise hard carbon, soft carbon, or graphite materials.

13. The method according to claim 12, wherein the graphite material comprises mesocarbon microbeads (MCMB).

14. The method according to claim 1, wherein the positive electrode plate comprises a positive electrode material.

15. The method according to claim 14, wherein the positive electrode material comprises lithium cobalt oxide, lithium ternary materials, lithium manganese oxide, lithium iron phosphate or lithium manganese iron phosphate, layered transition metal oxides, Prussian blue, polyanionic compounds, or tunnel-structured oxide.

16. The method according to claim 1, wherein the ion channels allow the passage of at least lithium ions, sodium ions, magnesium ions, potassium ions, aluminum ions, or zinc ions.

17. The method according to claim 1, wherein integrating the deposited thin film layer and the current collector, the positive electrode plate, or the negative electrode plate directly into an electrochemical device.

18. An electrochemical component having ordered ion channels, comprising sequentially the deposited thin film layer, the ordered ion channel layer, and the current collector, the positive electrode plate, or the negative electrode plate as described in claim 1.

19. The electrochemical component according to claim 18, wherein the electrochemical component is further immersed in a gel electrolyte or a liquid electrolyte.

20. An electrochemical device, comprising the electrochemical component having ordered ion channels as described in claim 18; and the electrochemical component is a metal ion battery, a metal battery, a metal ion-metal hybrid battery, or an anode-free battery.
